(19) United States
(12) Patent Application Publication
(10) Pub. No.: US 2023/0031547 A1
(43) Pub. Date: Feb. 2, 2023

(54) DRY ICE CRUSHING MECHANISM

(71) Applicant: INTRADIN (HUZHOU) PRECISION TECHNOLOGY CO.,LTD., Huzhou (CN)

(72) Inventors: Kaichun Wang, Huzhou (CN); Xiaobo Xu, Huzhou (CN)

(21) Appl. No.: 17/874,793

(22) Filed: Jul. 27, 2022

(30) Foreign Application Priority Data
Jul. 27, 2021 (CN) 202110851755.2

(51) Int. Cl. F25C 5/04; B08B 7/00; B08B 13/00

(52) U.S. Cl. CPC F25C 5/046; B08B 7/00; B08B 13/00

(57) ABSTRACT

The invention discloses a dry ice crushing mechanism, and relates to the technical field of a dry ice cleaning equipment. The dry ice crushing mechanism comprises a base, a filter screen mechanism, an ice crushing mechanism, a driving mechanism and a transmission mechanism, the filter screen mechanism is arranged in the base, the ice crushing mechanism is arranged in the filter screen mechanism, the driving mechanism is arranged on one side of the base, and the driving mechanism is connected with the filter screen mechanism through the transmission mechanism and is used for driving the ice crushing mechanism to rotate or swing in the filter screen mechanism. According to the dry ice crushing mechanism, ice is crushed in a rotating or swinging mode of the ice crushing mechanism, the dry ice particle refining efficiency can be obviously improved without changing the environment of an existing equipment.

### FIELD OF THE INVENTION

The invention relates to the technical field of a dry ice cleaning equipment, and more particularly, to a dry ice crushing mechanism.

### BACKGROUND OF THE INVENTION

Dry ice particle refining devices now can be divided into two categories—pure pneumatic refining devices and electric pneumatic hybrid refining devices, according to the power source. A pneumatic process creates a linear reciprocating motion. Dry ice particles are pressed and ground through the linear reciprocating motion, so that the dry ice is refined. However, the existing mechanisms have a lower ice crushing efficiency; or special equipment are needed to provide larger compressed gas, so extra costs for the equipment may added to the process, that is, users have to pay more for achieving this purpose. The electric pneumatic hybrid refining devices require the use of two power sources, namely, electricity and gas, so a lot of wires and tubes are used, thus, it is in such a mess. As a result, use of this type of device is limited.

### SUMMARY OF THE INVENTION

An object of the present invention is to provide a dry ice crushing mechanism for solving the above-mentioned technical problems.

The technical solutions adopted in the present invention are as follows:

a dry ice crushing mechanism, comprising: a base, a filter screen mechanism, an ice crushing mechanism, a driving mechanism and a transmission mechanism, wherein the filter screen mechanism is arranged in the base, the ice crushing mechanism is arranged in the filter screen mechanism, the driving mechanism is arranged on one side of the base, and the driving mechanism is connected with the filter screen mechanism through the transmission mechanism and is used for driving the ice crushing mechanism to rotate or swing in the filter screen mechanism.

Preferably, a middle portion of the base is inclined inward from top to bottom, a dry ice inlet orifice is arranged in the middle portion of the base, the filter screen mechanism is arranged in the dry ice inlet orifice, a receding groove is arranged on one side of the base, and the transmission mechanism is arranged in the receding groove.

More preferably, the filter screen mechanism comprises a cylindrical body and a filter screen arranged at a bottom of the cylindrical body, the ice crushing mechanism is rotatably arranged on an upper side of the filter screen, a dry ice access opening is formed at a side wall of the cylindrical body, and the dry ice access opening is in communication with the dry ice inlet orifice.

More preferably, the ice crushing mechanism comprises a connecting shaft and a plurality of ice crushing knives arranged at an outer peripheral wall of the connecting shaft, one end of the connecting shaft is rotatably connected to an inner wall of one end of the cylindrical body, the other end of the connecting shaft extends out of the cylindrical body and is connected to the driving mechanism through the transmission mechanism.

More preferably, the transmission mechanism comprises a shaft sleeve, a gear and a rack, the shaft sleeve and the gear are sequentially sleeved on the other end of the connecting shaft, the connecting shaft is rotatably connected to an inner wall of the base through the shaft sleeve, the rack is located in the receding groove and meshes with the gear, and one end of the rack is connected to the driving mechanism.

Preferably, the base comprises two symmetrically disposed fixed blocks, the two fixed blocks are detachably connected to each other, and a chamber is formed between the two fixed blocks, and the filter screen mechanism is arranged in the chamber.

More preferably, the filter screen mechanism comprises a semi-annular base plate, two connecting plates arranged at two ends of the base plate, and a filter screen arranged on the base plate, the base plate is fixed in the chamber through the two connecting plates, and the ice crushing mechanism is swingably arranged at an upper side of the filter screen.

More preferably, the ice crushing mechanism comprises a connecting shaft and a swing arm sleeved on the connecting shaft, the plurality of ice crushing knives are arranged at an end, away from the connecting shaft, of the swing arm.

More preferably, the transmission mechanism comprises a connecting rod, a connecting arm, two bearings, a support frame, two bushings, two support blocks and a connecting block, two ends of the connecting shaft are rotatably connected to the two fixed blocks through the two bearings, one end of the connecting rod is connected to one end of the connecting shaft, the other end of the connecting rod is rotatably connected to one end of the connecting arm, the support frame is arranged on the driving mechanism, two ends of the support frame is rotatably connected to the two support blocks through the two bushings, the two support blocks are connected to the connecting block, and the connecting block is fixed on one side of the base.

A dry ice cleaning machine comprising the dry ice crushing mechanism as described above.

More preferably, the dry ice cleaning machine further comprises an ice stirring mechanism arranged at an upper end of the dry ice crushing mechanism;

wherein the ice stirring mechanism comprises a thermal insulation barrel, a stirring rod assembly and a connecting rod assembly, the thermal insulation barrel is arranged at an upper end of the base, the stirring rod assembly is arranged inside the thermal insulation barrel, and the connecting rod assembly connects the stirring rod assembly and the rack.

More preferably, the dry ice cleaning machine further comprises a folding spraying gun, wherein the folding spraying gun is in communication with the dry ice crushing mechanism through a connecting pipe;

wherein the folding spraying gun comprises a spraying gun handle, a spray head and a locking device, the spraying gun handle is in communication with the base through the connecting pipe, the spray head is rotatably connected to the spraying gun handle, and the spray head is locked with the spraying gun handle through the locking device.

By adopting the above-mentioned technical solutions, the present invention has the beneficial effects that according to the dry ice crushing mechanism, ice is crushed in a rotating or swinging mode of the ice crushing mechanism, the dry ice particle refining efficiency can be obviously improved without changing the environment of an existing equipment, and the dry ice crushing mechanism is simple in structure, high in efficiency, stable and reliable.

### BRIEF DESCRIPTION OF THE DRAWINGS

FIG. 1 is front view of a dry ice crushing mechanism in Example 1,

FIG. 2 is perspective view of a dry ice crushing mechanism in Example 1;

FIG. 3 is an exploded view of a dry ice crushing mechanism in Example 1;

FIG. 4 is front view of a dry ice crushing mechanism in Example 2;

FIG. 5 is perspective view of a dry ice crushing mechanism in Example 2;

FIG. 6 is an exploded view of a dry ice crushing mechanism in Example 2;

FIG. 7 is a schematic view I showing structures of a thermal insulation barrel, a stirring rod assembly and a power assembly according to the invention;

FIG. 8 is a schematic view II showing structures of a thermal insulation barrel, a stirring rod assembly and a power assembly according to the invention;

FIG. 9 is a schematic view I showing a structure of a folding spraying gun according to the invention;

FIG. 10 is a schematic view II showing a structure of a folding spraying gun according to the invention; and

FIG. 11 is an enlarged view of A indicated in FIG. 10.

Reference numerals in the accompanying drawings: 1. base; 2. dry ice inlet orifice; 3. receding groove; 4. cylindrical body; 5. filter screen; 6. dry ice access opening; 7. connecting shaft; 8. ice crushing knife; 9. shaft sleeve; 10. gear; 11. rack; 12. fixed block; 13. base plate; 14. connecting plate; 15. swing arm; 16. connecting rod; 17. connecting arm; 18. bearing; 19. support frame; 20. bushing; 21. support block; 22. connecting block; 23. cylinder; 24. chamber; 25. thermal insulation barrel; 26. stirring rod assembly; 261. horizontal rotating lever; 262. vertical rotating lever; 27. connecting rod assembly; 271 first connecting rod; 272. second connecting rod; 28. folding spraying gun; 281. spraying gun handle; 2811. handle seat; 2812. rotating arm; 2813. axis of rotation; 2814. adjusting block; 2815. connecting pipe; 282, spray head; 283. locking device.

### DETAILED DESCRIPTION

The technical solution in the embodiments of the present invention will now be described clearly and fully hereinafter with reference to the accompanying drawings. Obviously, the embodiments described herein are only parts of the embodiments instead of all the embodiments. It should be understood that all the other embodiments obtained from the embodiments presented in the present invention by one skilled in the art without any creative work are all construed to fall into the scope of the present invention.

Throughout the description of the invention, it should be noted that the terms “middle”, “upper”, “lower”, “left”, “right”, “vertical”, “horizontal”, “inner”, and “outer” are intended to orientation or position relationship based on the orientation or position relationship shown in figures, and they are solely for illustrating the present invention or simplifying the invention, and do not imply that devices or elements must have a specific orientation, be constructed and operated at the specific orientation, so these and similar directional terms should not be construed to limit the scope of the invention. Moreover, the ordinal terms “first”, “second”, and “third” do not connote or imply relative importance but are used for illustrative purposes.

Throughout the description of the invention, it should be noted that the terms “mounted”, “connected to”, if any, are to be construed in a broad sense, unless the context otherwise stated. For example, “connected to” can be intended to include fixedly connected to, or removably connected to, or integrally connected to; or it may be intended to include mechanical connection, or electrical connection; or direct connection, or indirect connection achieved through a medium, or internal communication between two elements. For these skilled in the art, the above-mentioned terms can be known in the present invention depending on different situations.

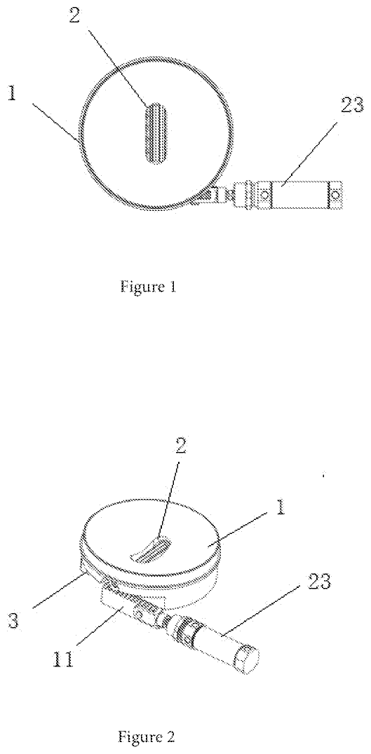

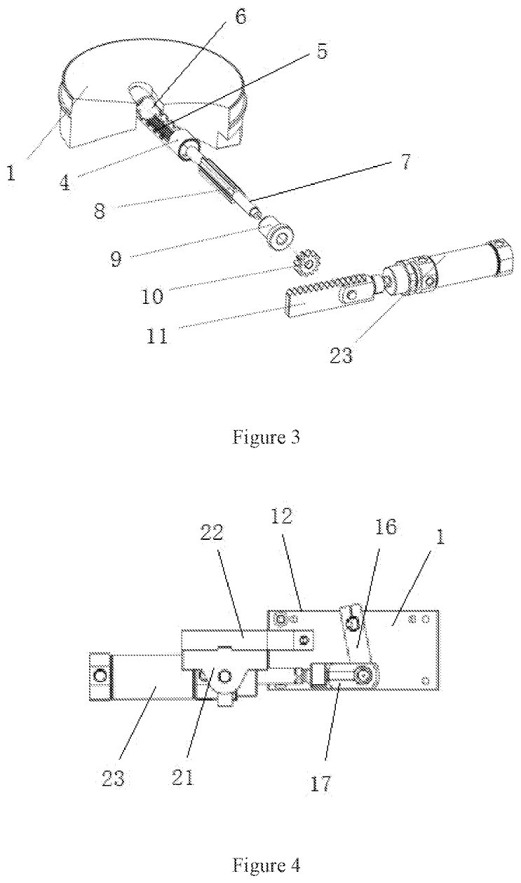

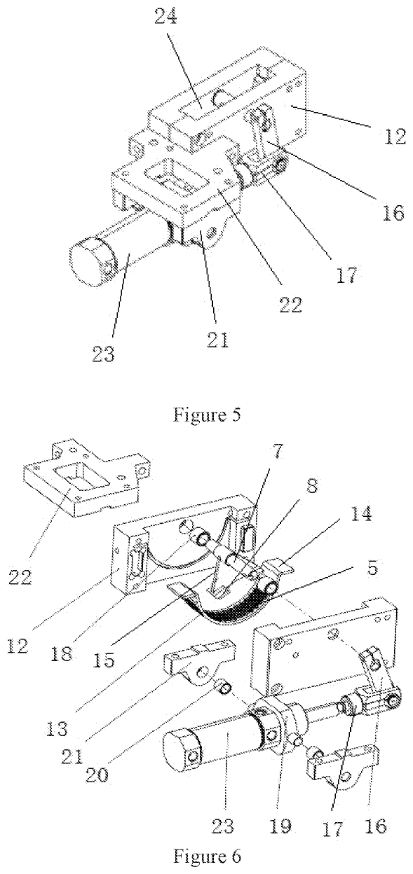

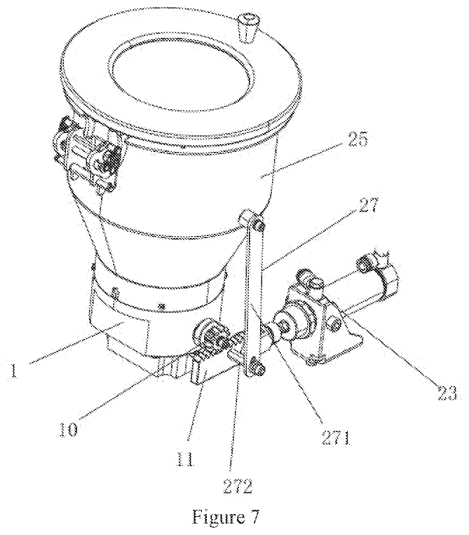

FIG. 1 is front view of a dry ice crushing mechanism in Example 1; FIG. 2 is perspective view of a dry ice crushing mechanism in Example 1; FIG. 3 is an exploded view of a dry ice crushing mechanism in Example 1; FIG. 4 is front view of a dry ice crushing mechanism in Example 2; FIG. 5 is perspective view of a dry ice crushing mechanism in Example 2; and FIG. 6 is an exploded view of a dry ice crushing mechanism in Example 2. With reference to FIGS. 1-6, two preferred embodiments are shown.

### Example 1

As shown in FIGS. 1-3, a dry ice crushing mechanism, comprising: a base 1, a filter screen mechanism, an ice crushing mechanism, a driving mechanism and a transmission mechanism, wherein the filter screen mechanism is arranged in the base 1, the ice crushing mechanism is arranged in the filter screen mechanism, the driving mechanism is arranged on one side of the base 1, and the driving mechanism is connected with the filter screen mechanism through the transmission mechanism and is used for driving the ice crushing mechanism to rotate or swing in the filter screen mechanism. In this example, the filter screen mechanism is removably connected to the base 1. The ice crushing mechanism is used for crushing the dry ice, so that ice can be crushed into particles of a certain thickness. The dry ice particles exit the base 1 after being filtered by the filter screen mechanism, and the driving mechanism is used to drive the ice crushing mechanism to rotate. The transmission mechanism is used to connect the driving mechanism and the ice crushing mechanism.

Furthermore, as a preferred embodiment, a middle portion of the base 1 is inclined inward from top to bottom, a dry ice inlet orifice 2 is arranged in the middle portion of the base 1, the filter screen mechanism is arranged in the dry ice inlet orifice 2, a receding groove 3 is arranged on one side of the base 1, and the transmission mechanism is arranged in the receding groove 3. In this example, the base 1 is an annular columnar structure, the middle portion of the base 1 is inclined downward, and enters into the dry ice inlet orifice 2 with the ice, then enters the filter screen mechanism through the dry ice inlet orifice 2.

Furthermore, as a preferred embodiment, the filter screen mechanism comprises a cylindrical body 4 and a filter screen 5 arranged at a bottom of the cylindrical body 4, the ice crushing mechanism is rotatably arranged on an upper side of the filter screen 5, a dry ice access opening 6 is formed at a side wall of the cylindrical body 4, and the dry ice access opening 6 is in communication with the dry ice inlet orifice 2. in this example, the filter screen mechanism is cylindrical as a whole, with one end open and the other end closed. The dry ice access opening 6 on the side wall allows an easy entry of the dry ice. Upper sides of the two side walls of the dry ice access opening 6 are arranged in a wavy structure for matching with the plurality of ice crushing knives 8, so that the dry ice can be crushed quickly. When the ice crushing knives 8 cut the dry ice, parts of the dry ice may be struck in the wavy structure, allowing parts of dry ice particles to be broken. In this embodiment, the side wall of the cylindrical body 4 is connected to the side wall of the dry ice inlet orifice 2, and both of them can be fixed to each other by means of a shaft sleeve limiting fitting screws. Through-holes are formed in the bottom of the cylindrical body 4 for permitting the dry ice particles to leave, and the filter screen 5 covers the through-holes.

Furthermore, as a preferred embodiment, the ice crushing mechanism comprises a connecting shaft 7 and a plurality of ice crushing knives 8 arranged at an outer peripheral wall of the connecting shaft 7, one end of the connecting shaft 7 is rotatably connected to an inner wall of one end of the cylindrical body 4, the other end of the connecting shaft 7 extends out of the cylindrical body 4 and is connected to the driving mechanism through the transmission mechanism. In this embodiment, the driving mechanism is a cylinder 23 and is used for driving the connecting shaft 7 to rotate forward and reverse, and the connecting shaft 7 drives the ice crushing knives 8 to rotate forward and reverse to crush the dry ice. The shape of the ice crushing knives 8 includes, but not limited to, a rhombus, a triangle, an olive, or an ellipse.

Furthermore, as a preferred embodiment, the transmission mechanism comprises a shaft sleeve 9, a gear 10 and a rack 11. The shaft sleeve 9 and the gear 10 are sequentially sleeved on the other end of the connecting shaft 7, the connecting shaft 7 is rotatably connected to an inner wall of the base 1 through the shaft sleeve 9, the rack 11 is located in the receding groove 3 and meshes with the gear 10, and one end of the rack 11 is connected to the driving mechanism. In this embodiment, the connecting shaft 7 is fixed in the cylindrical body 4 through the shaft sleeve 9. The ice crushing knives 8 are driven by the connecting shaft 7 to rotate in the filter screen mechanism. The cylinder 23 pushes the rack 11 to make a reciprocating linear motion. The rack 11 drives the gear 10 to make a forward and reverse rotation. The gear 10 drives the ice crushing knives 8 to make a forward and reverse motion, so that the dry ice particles are ground and refined, and the refined particles are filtered through the filter screen 5.

### Example 2

As shown in FIGS. 4-6, the base 1 comprises two symmetrically disposed fixed blocks 12, the two fixed blocks 12 are detachably connected to each other, and a chamber 24 is formed between the two fixed blocks 12. The filter screen mechanism is arranged in the chamber 24. In this embodiment, the two fixed blocks 12 are connected by bolts. The chamber 24, arranged between the two fixed blocks 12, is a slot with openings at upper and lower ends thereof, allowing the entry and exit of the dry ice particles.

Furthermore, as a preferred embodiment, the filter screen mechanism comprises a semi-annular base plate 13, two connecting plates 14 arranged at two ends of the base plate 13, and a filter screen 5 arranged on the base plate 13, the base plate 13 is fixed in the chamber 24 through the two connecting plates 14, and the ice crushing mechanism is swingably arranged at an upper side of the filter screen 5. As shown in FIG. 6, an inner side wall of each of the two fixed blocks 12 is provided with an arc-shaped sliding chute and fixing slots arranged at both ends of the sliding chute, wherein the base plate 13 is arranged in the sliding chute, the connecting plates 14 are fixed in the fixing slots. An opening for the passage of the dry ice particles are formed in the base plate 13. The filter screen 5 covers the opening, the dry ice particles are filtered through the filter screen 5 and exit the base 1 through the opening.

Furthermore, as a preferred embodiment, the ice crushing mechanism comprises a connecting shaft 7 and a swing arm 15 sleeved on the connecting shaft 7, the plurality of ice crushing knives 8 are arranged at an end, away from the connecting shaft 7, of the swing arm 15.

Furthermore, as a preferred embodiment, the transmission mechanism comprises a connecting rod 16, a connecting arm 17, two bearings 18, a support frame 19, two bushings 20, two support blocks 21 and a connecting block 22, two ends of the connecting shaft 7 are rotatably connected to the two fixed blocks through the two bearings 17, one end of the connecting rod 16 is connected to one end of the connecting shaft 7, the other end of the connecting rod 16 is rotatably connected to one end of the connecting arm 17, the support frame 19 is arranged on the driving mechanism, two ends of the support frame 19 is rotatably connected to the two support blocks 21 through the two bushings 20, the two support blocks 21 are connected to the connecting block 22, and the connecting block 22 is fixed on one side of the base 1. In this embodiment, as shown in FIG. 6, the movement of the cylinder 23 acts as the power source. The cylinder 23 can rotate relative to the connecting block 22 under the action of the support frame 19. When the cylinder 23 drives the connecting arm 17 to drive the connecting rod 16 to rotate, the connecting rod 16 drives the connecting shaft 7 to rotate back and forth, and the connecting shaft 7 drives the swing arm 15 and the ice crushing knives 8 to swing forward and reverse. The forward and reverse swing of the ice crushing knives 8 crushes and refines the dry ice particles. And the refined dry ice particles exit the base 1 through the opening. The dry ice crushing mechanism in the embodiment can be used as a dry ice cleaning equipment to refine the dry ice particle mechanism, and the dry ice crushing mechanism is simple in structure, high in efficiency, stable and reliable.

The invention provides a dry ice cleaning machine on the basis of two above-mentioned examples, and the dry ice cleaning machine comprises the dry ice crushing mechanism.

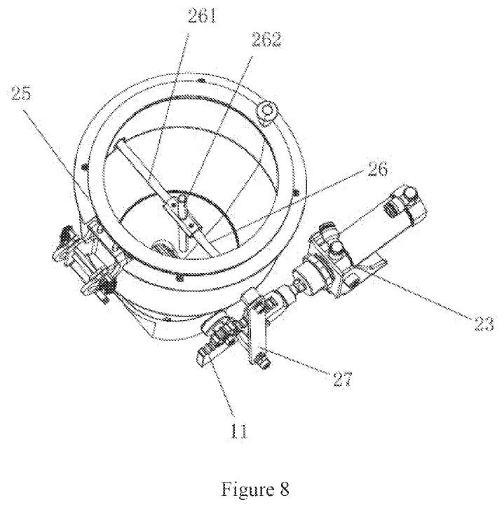

Furthermore, as a preferred embodiment, the dry ice cleaning machine further comprises an ice stirring mechanism arranged at an upper end of the dry ice crushing mechanism.

Wherein the ice stirring mechanism comprises a thermal insulation barrel 25, a stirring rod assembly 26 and a connecting rod assembly 27, the thermal insulation barrel 25 is arranged at an upper end of the base 1 in the ice crushing mechanism, the stirring rod assembly 26 is arranged inside the thermal insulation barrel 25, and the connecting rod assembly 27 connects the stirring rod assembly 26 and the rack 11. In this embodiment, as shown in FIGS. 7 and 8, the thermal insulation barrel 25 is installed at the upper end of the base 1, the dry ice in the thermal insulation barrel 25 can enter into the base 1, and the dry ice is crushed by the ice crushing knives in the base 1. The crushed dry ice forms dry ice particles, and the dry ice particles leave the base 1 from the bottom of the base 1. Wherein, the stirring rod assembly 26 is used for stirring the dry ice in the thermal insulation barrel 25, preventing the dry ice from agglomerating in the thermal insulation barrel 25.

Wherein, the stirring rod assembly 26 comprises a horizontal rotating lever 261 and a vertical rotating lever 262. Both ends of the horizontal rotating level 261 are rotatably connected to inner walls at two sides of the thermal insulation barrel 25. One end of the horizontal rotating lever 261 extends out of the thermal insulation barrel 25 and is connected with the connecting rod assembly 27. The vertical rotating lever 262 and the horizontal rotating lever 261 are crossed. Referring to FIG. 8, wherein, the vertical rotating lever 262 is connected with the horizontal rotating lever 261, and the vertical rotating lever 262 is vertically arranged inside the thermal insulation barrel 25. The horizontal rotating lever 261 is horizontally arranged inside the thermal insulation barrel 25, and the horizontal rotating lever 261 and the vertical rotating lever 262 are crossed. The rotation of the horizontal rotating lever 261 drives the vertical rotating lever 262 to swing, so as to stir the dry ice in the thermal insulation bucket 25. Referring to FIG. 8, when the vertical rotating lever 262 swings, both upper and lower ends of the vertical rotating lever 262 can stir the dry ice, and can also stir the dry ice on the upper side and the bottom side of the thermal insulation barrel 25.

In this embodiment, as shown in FIG. 8, the connecting rod assembly 27 comprises a first connecting rod 271 and a second connecting rod 272. One end of the first connecting rod 271 is connected to one end of the horizontal rotating lever 261. The second connecting rod 272 is arranged on the rack, and the other end of the first connecting rod 271 is connected to the second connecting rod 272. When the cylinder 23 drives the rack 11 to make a reciprocating motion, the rack 11 drives the second connecting rod 272 to move, and the second connecting rod 272 drives the first connecting rod 271 to make a reciprocating swinging movement, so that the first connecting rod 271 drives the horizontal rotating lever 261 to rotate back and forth, clockwise and counterclockwise, and the horizontal rotating lever 261 drives the vertical rotating lever 262 to make a reciprocating swinging movement, thus stirring of the dry ice in the thermal insulation 25 can be achieved, and the dry ice is prevented from agglomerating.

Furthermore, as a preferred embodiment, the dry ice cleaning machine further comprises a folding spraying gun 28, wherein the folding spraying gun 28 is in communication with the dry ice crushing mechanism through a connecting pipe 2815.

The folding spraying gun 28 comprises a spraying gun handle 281, a spray head 282 and a locking device, the spraying gun handle 281 is in communication with the bottom of the base 1. The spray head 282 is rotatably connected to the spraying gun handle 281, and the spray head 282 is locked with the spraying gun handle 281 through the locking device. Wherein, a bottom of the dry ice crushing mechanism refers to the bottom of the base 1. Wherein, the locking device is a locking knob 283.

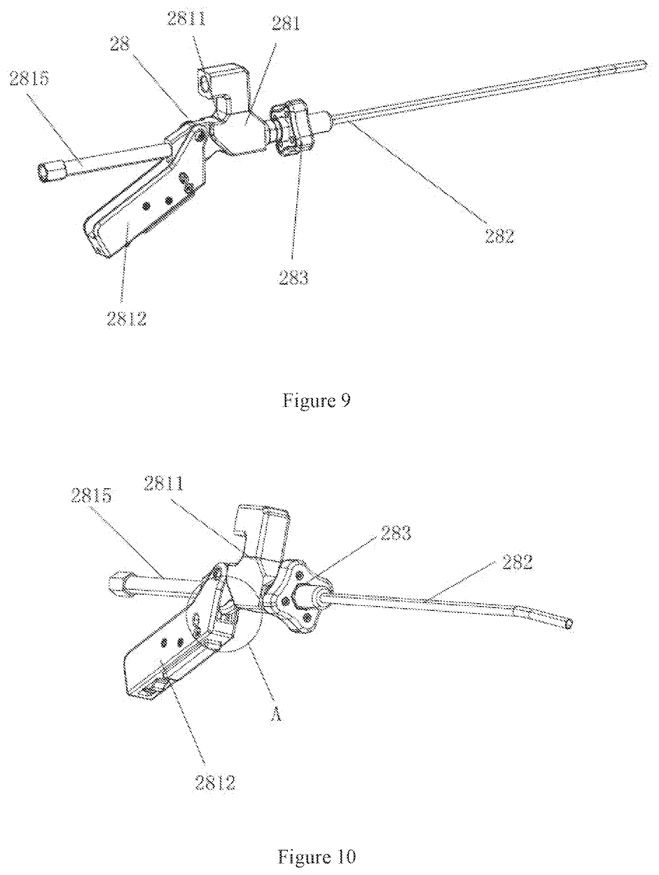

Referring to FIGS. 9-11, one end of the spraying gun handle 281 is in communication with the bottom of the base through a connecting pipe 2815, and the spray head 282 is connected to the other end of the spraying gun handle 281. The spray head 282 is in communication with the connecting pipe 2815. The dry ice inside the base 1 is crushed and leaves the base 1 and enters into the folding spraying gun 28 through the connecting pipe 2815. Then the spraying of the dry ice is done by the folding spraying gun 28. Wherein, the spray head 282 can be rotated so that an angel of the spray head 282 is adjusted, and thus an angel from which the dry ice is sprayed can be adjusted. The spray head 282 is in threaded connection with the spraying gun handle 281. After the spray head 282 is threadedly connected with the spraying gun handle 281, the spray head 282 is locked and fixed to the spraying gun handle 281 by turning the locking knob 283.

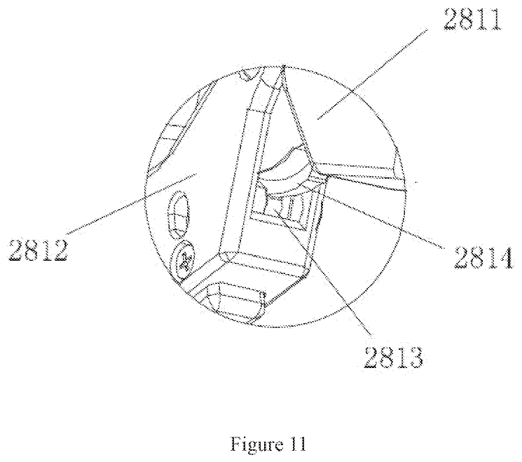

In this embodiment, as shown in FIG. 10, the spraying gun handle comprises a handle base 2811 and a rotating arm 2812 rotatably connected to a bottom of the handle base 2811. The connecting pipe 2815 and the spray head 282 are connected to the handle base 2811, respectively. Wherein, the connecting pipe 2815 partially runs into the handle base 2811. The bottom of the handle base 2811 is also provided with an adjusting block 2814, the adjusting block 2814 can enter the handle base 2811, and a spring can be arranged in the handle base 2811 to fit with the adjusting block 2814 so as to facilitate the reset of the adjusting block 2814. A bottom of the adjusting block 2814 is of an arc shape. A rotating shaft 2813 is arranged on a side, close to the handle base 2811, inside the rotating arm 2812. An outer peripheral wall of the rotating shaft 2813 is matched with an arc-shaped wall at the bottom of the adjusting block 2814. When rotating the rotating arm 2812, the rotating arm 2812 drives the rotating shaft 2813 to move in a first direction, the outer peripheral wall of the rotating shaft 2813 moves at the bottom wall of the adjusting block 2814, so as to squeeze the adjusting block 2814, so that the adjusting block 2814 enters inside the handle base 2811 and squeezes the connecting pipe 2815 to control the spray flow of dry ice particles. When the rotating arm 2812 drives the rotating shaft 2813 to move in a second direction, the adjusting block 2814 can be reset under the action of the spring, and the connecting pipe 2815 will not be squeezed by the adjusting block 2814. The rotating arm 2812 in this embodiment can be opposite to the handle base 2811 and can be adapted to different applications.

The above descriptions are only the preferred embodiments of the invention, not thus limiting the embodiments and scope of the invention. Those skilled in the art should be able to realize that the schemes obtained from the content of specification and drawings of the invention are within the scope of the invention.

What is claimed is:

1. A dry ice crushing mechanism, comprising: a base, a filter screen mechanism, an ice crushing mechanism, a driving mechanism and a transmission mechanism, wherein the filter screen mechanism is arranged in the base, the ice crushing mechanism is arranged in the filter screen mechanism, the driving mechanism is arranged on one side of the base, and the driving mechanism is connected with the filter screen mechanism through the transmission mechanism and is used for driving the ice crushing mechanism to rotate or swing in the filter screen mechanism.

2. The dry ice crushing mechanism of claim 1, wherein a middle portion of the base is inclined inward from top to bottom, a dry ice inlet orifice is arranged in the middle portion of the base, the filter screen mechanism is arranged in the dry ice inlet orifice, a receding groove is arranged on one side of the base, and the transmission mechanism is arranged in the receding groove.

3. The dry ice crushing mechanism of claim 2, wherein the filter screen mechanism comprises a cylindrical body and a filter screen arranged at a bottom of the cylindrical body, the ice crushing mechanism is rotatably arranged on an upper side of the filter screen, a dry ice access opening is formed at a side wall of the cylindrical body, and the dry ice access opening is in communication with the dry ice inlet orifice.

4. The dry ice crushing mechanism of claim 3, wherein the ice crushing mechanism comprises a connecting shaft and a plurality of ice crushing knives arranged at an outer peripheral wall of the connecting shaft, one end of the connecting shaft is rotatably connected to an inner wall of one end of the cylindrical body, the other end of the connecting shaft extends out of the cylindrical body and is connected to the driving mechanism through the transmission mechanism.

5. The dry ice crushing mechanism of claim 4, wherein the transmission mechanism comprises a shaft sleeve, a gear and a rack, the shaft sleeve and the gear are sequentially sleeved on the other end of the connecting shaft, the connecting shaft is rotatably connected to an inner wall of the base through the shaft sleeve, the rack is located in the receding groove and meshes with the gear, and one end of the rack is connected to the driving mechanism.

6. The dry ice crushing mechanism of claim 1, wherein the base comprises two symmetrically disposed fixed blocks, the two fixed blocks are detachably connected to each other, and a chamber is formed between the two fixed blocks, and the filter screen mechanism is arranged in the chamber.

7. The dry ice crushing mechanism of claim 6, wherein the filter screen mechanism comprises a semi-annular base plate, two connecting plates arranged at two ends of the base plate, and a filter screen arranged on the base plate, the base plate is fixed in the chamber through the two connecting plates, and the ice crushing mechanism is swingably arranged at an upper side of the filter screen.

8. The dry ice crushing mechanism of claim 7, wherein the ice crushing mechanism comprises a connecting shaft and a swing arm sleeved on the connecting shaft, the plurality of ice crushing knives are arranged at an end, away from the connecting shaft, of the swing arm.

9. The dry ice crushing mechanism of claim 7, wherein the transmission mechanism comprises a connecting rod, a connecting arm, two bearings, a support frame, two bushings, two support blocks and a connecting block, two ends of the connecting shaft are rotatably connected to the two fixed blocks through the two bearings, one end of the connecting rod is connected to one end of the connecting shaft, the other end of the connecting rod is rotatably connected to one end of the connecting arm, the support frame is arranged on the driving mechanism, two ends of the support frame is rotatably connected to the two support blocks through the two bushings, the two support blocks are connected to the connecting block, and the connecting block is fixed on one side of the base.

10. A dry ice cleaning machine comprising the dry ice crushing mechanism of claim 1.

11. The dry ice cleaning machine of claim 10, further comprising: an ice stirring mechanism arranged at an upper end of the dry ice crushing mechanism;
wherein the ice stirring mechanism comprises a thermal insulation barrel, a stirring rod assembly and a connecting rod assembly, the thermal insulation barrel is arranged at an upper end of the base, the stirring rod assembly is arranged inside the thermal insulation barrel, and the connecting rod assembly connects the stirring rod assembly and the rack.

12. The dry ice cleaning machine of claim 10, further comprising: a folding spraying gun, wherein the folding spraying gun is in communication with the dry ice crushing mechanism through a connecting pipe;
wherein the folding spraying gun comprises a spraying gun handle, a spray head and a locking device, the spraying gun handle is in communication with the base through the connecting pipe, the spray head is rotatably connected to the spraying gun handle, and the spray head is locked with the spraying gun handle through the locking device.
